(19) United States
(12) Patent Application Publication
(10) Pub. No.: US 2025/0133606 A1
(43) Pub. Date: Apr. 24, 2025

(54) UNIQUENESS OF PDU SESSION ID IN A COMMUNICATIONS NETWORK

(71) Applicant: Telefonaktiebolaget LM Ericsson (publ), Stockholm (SE)

(72) Inventors: Juying GAN, Shanghai (CN); Yunjie LU, Shanghai (CN)

(21) Appl. No.: 18/705,188

(22) PCT Filed: Oct. 12, 2022
(86) PCT No.: PCT/EP2022/078387

§ 371 Date: Apr. 26, 2024

(30) Foreign Application Priority Data
Oct. 29, 2021 (WO) PCT/CN2021/127618

(51) Int. Cl. H04W 76/10; H04W 60/00; H04W 76/20

(52) U.S. Cl. CPC H04W 76/10; H04W 60/00; H04W 76/20

(57) ABSTRACT

Methods, network nodes, and computer readable storage media for ensuring uniqueness of an assigned PDU Session ID are disclosed. The method at a first network node includes: transmitting, to a second network node, during establishment of a Packet Data Network (PDN) connection, a request message for retrieving a list of PDU Session ID(s) that have been already registered for a User Equipment (UE); and receiving a response message from the second network node. The second network node is a Unified Data Management (UDM).

### TECHNICAL FIELD

The present disclosure relates to wireless communications, and in particular to methods, network nodes, and computer readable storage media for ensuring uniqueness of an assigned Packet Data Unit (PDU) Session ID.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

Per 3^{rd} Generation Partnership Project (3GPP) Technical Specification (TS) 23.502 v17.1.0 (which is incorporated herein in its entirety by reference), in order for a User Equipment (UE) not supporting 5G Core (5GC) Non-Access Stratum (NAS) (also described as a UE not supporting 5G) to establish a Packet Data Network (PDN) connection over 4G system, e.g., Evolved Packet System (EPS), or over EPS Core (EPC)/evolved Packet Data Gateway (ePDG), e.g., Wireless Fidelity (Wi-Fi), the Session Management Function (SMF)+PDN Gateway-Control plane (PGW-C) assigns/creates a unique PDU Session ID for the PDN connection. The uniqueness of the assigned PDU Session ID may be ensured based on the EPS Bearer IDs assigned by the Mobility Management Entity (MME) or ePDG for the PDN Connections associated with the UE which is not in the range of PDU Session ID values that may be created by a UE capable of 5G, i.e., a 5GC NAS capable UE.

Table 1 below (corresponding to Table 5.4.2-1 of 3GPP TS 29.571 v17.3.0) shows Simple Data Types, in which the relationship between a PDU Session ID of a PDN connection (established via MME and ePDG respectively) and an EPS bearer ID of a default EPS bearer of the PDN connection are illustrated.

TABLE 1

| Type | Type | |
|---|---|---|
| Name | Definition | Description |
| . . . | | . . . |
| PduSessionId | integer | Unsigned integer identifying a PDU session, within |
| | | the range 0 to 255, as specified in |
| | | clause 11.2.3.1b, bits 1 to 8, of 3GPP TS 24.007 |
| | | v17.2.0. If the PDU Session ID is allocated by the |
| | | Core Network for UEs not supporting N1 mode, |
| | | reserved range 64 to 95 is used. PDU Session ID |
| | | within the reserved range is only visible in the |
| | | Core Network (NOTE). |
| . . . | . . . | . . . |

(NOTE)
For a PDN connection established via MME, the PDU Session ID value is set to 64 plus the EPS bearer ID of the default EPS bearer of the PDN connection; for a PDN connection established via ePDG, the PDU Session ID value is set to 80 plus the EPS bearer ID of the default EPS bearer of the PDN connection.

However, the uniqueness of the SMF+PGW-C assigned PDU Session ID may not be possible to be achieved in some scenarios.

For example, the UE may establish a PDN connection towards Access Point Name (APN) 1 via MME, the MME may use a default EPS Bearer ID (EBI) ‘5’. Thus, the SMF+PGW-C may assign ‘69’ as a PDU Session ID (i.e., PSID, both of which may be used interchangeably throughout the document). Then, the UE may perform handover from EPS to EPC/ePDG (e.g., from 4G to Wi-Fi), and the PSID ‘69’ continues to be used. Then, the UE may establish a PDN connection towards APN2 via the MME, and the MME may use the default EBI ‘5’ again. In this case, the same PSID ‘69’ that has been assigned by the SMF+PGW-C may be assigned again, regardless of the same or different SMF+PGW-C(s) are involved.

As a consequence, the PSID is repetitively used for different PDN connections of the UE, and the previous PDN connection (which should be kept) may be deleted unexpectedly.

### SUMMARY

In order to at least solve the problems as described above, the embodiments of the present disclosure provide a mechanism to avoid possible duplicated PDU Session ID assigned by the SMF+PGW-C to different PDN connections of the UE, ensuring uniqueness of the assigned PDU Session ID.

According to a first aspect of the present disclosure, a method at a first network node is provided. The method includes transmitting (S101), to a second network node, during establishment of a Packet Data Network ‘PDN’ connection, a request message for retrieving a list of Packet Data Unit ‘PDU’ Session ID(s) that have been already registered for a User Equipment ‘UE’; and receiving (S103) a response message from the second network node; wherein the second network node is a Unified Data Management ‘UDM’.

In an exemplary embodiment, the response message comprises a list of PDU Session ID(s) that have been already registered for PDN connections established by the UE, and the method further comprises assigning, for the PDN connection being established by the UE, a PDU Session ID that is not within the received list of PDU Session ID(s).

In an exemplary embodiment, the request message is transmitted via an Nudm_UECM_Get request service operation, and the response message is received via an Nudm_UECM_Get response service operation.

In an exemplary embodiment, the method further comprises, in a case where the PDN connection assigned with the PDU Session ID is successfully established, transmitting, to the second network node, registration information comprising the assigned PDU Session ID.

In an exemplary embodiment, the registration information comprising the assigned PDU Session ID is transmitted via an Nudm_UECM_Registration service operation.

In an exemplary embodiment, the UE does not support 5G, and the first network node is Session Management Function ‘SMF’+PDN Gateway-Control plane ‘PGW-C’.

In an exemplary embodiment, the request message comprises a request message for retrieving only the list of PDU Session ID(s) that have been assigned for PDN connections established by the UE.

In an exemplary embodiment, the request message comprises a request message for retrieving registration information that comprises the list of PDU Session ID(s) that have been assigned for PDN connections established by the UE.

In an exemplary embodiment, the response message comprises no or an empty list of PDU Session ID(s) that have been assigned for PDN connections established by the UE, and the method further comprises assigning a PDU Session ID for a PDN connection being established by the UE.

In an exemplary embodiment, the list of PDU Session ID(s) is comprised in registration information in the response message.

According to a second aspect of the present disclosure, a method performed by a second network node is provided. The method includes receiving (S201), from a first network node, during establishment of a Packet Data Network ‘PDN’ connection, a request message for retrieving a list of Packet Data Unit ‘PDU’ Session ID(s) that have been already registered for a User Equipment ‘UE’; and transmitting (S203) a response message to the first network node; wherein the second network node is a Unified Data Management ‘UDM’.

In an exemplary embodiment, the response message comprises a list of PDU Session ID(s) that have been already registered for PDN connections established by the UE.

In an exemplary embodiment, the request message is received via an Nudm_UECM_Get request service operation, and the response message is transmitted via an Nudm_UECM_Get response service operation.

In an exemplary embodiment, the method further comprises, in a case where the PDN connection assigned by the first network node with the PDU Session ID is successfully established, receiving, from the first network node, registration information comprising the PDU Session ID assigned by the first network node.

In an exemplary embodiment, the registration information comprising the PDU Session ID assigned by the first network node is received via an Nudm_UECM_Registration service operation.

In an exemplary embodiment, the UE does not support 5G, and the first network node is Session Management Function ‘SMF’+PDN Gateway-Control plane ‘PGW-C’.

In an exemplary embodiment, the request message comprises a request message for retrieving only the list of PDU Session ID(s) that have been assigned for PDN connections established by the UE.

In an exemplary embodiment, the request message comprises a request message for retrieving registration information that comprises the list of PDU Session ID(s) that have been assigned for PDN connections established by the UE.

In an exemplary embodiment, the response message comprises one of no list of PDU Session ID(s) that have been assigned for PDN connections established by the UE, and an empty list of PDU Session ID(s) that have been assigned for PDN connections established by the UE.

In an exemplary embodiment, the list of PDU Session ID(s) is comprised in registration information in the response message.

According to a third aspect of the present disclosure, a first network node is provided. The first network node includes: at least one processor, and at least one memory, storing instructions which, when executed on the at least one processor, cause the first network node to perform any of the methods according to the first aspect of the present disclosure.

According to a fourth aspect of the present disclosure, a second network node is provided. The second network node includes: at least one processor, and at least one memory, storing instructions which, when executed on the at least one processor, cause the second network node to perform any of the methods according to the second aspect of the present disclosure.

According to a fifth aspect of the present disclosure, a computer readable storage medium is provided. The computer readable storage medium has computer program instructions stored thereon, the computer program instructions, when executed by at least one processor, causing the at least one processor to perform any of the methods according to any of the first to second aspects of the present disclosure.

With the technical solutions according to the exemplary embodiments of the present disclosure as described above, possible duplicated PDU Session ID assigned by the first network node, such as SMF+PGW-C, to different PDN connections of the UE may be avoided, which may ensure uniqueness of the assigned PDU Session ID.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 schematically shows a method performed by a first network node for ensuring uniqueness of a PDU Session ID assigned for a PDN connection being established by a UE according to an exemplary embodiment of the present disclosure;

FIG. 2 schematically shows a method performed by a second network node for ensuring uniqueness of a PDU Session ID assigned for a PDN connection being established by a UE according to an exemplary embodiment of the present disclosure;

FIG. 3 schematically shows an exemplary signaling sequence in an exemplary PDN connection establishment process from a UE not supporting 5G via MME, in which the methods of FIGS. 1 and 2 according to the exemplary embodiments of the present disclosure may be applied;

FIG. 4 schematically shows another exemplary signaling sequence in an exemplary PDN connection establishment process from a UE not supporting 5G via ePDG, in which the methods of FIGS. 1 and 2 according to the exemplary embodiments of the present disclosure may be applied;

FIG. 5 schematically shows a structural block diagram of a first network node according to an exemplary embodiment of the present disclosure;

FIG. 6 schematically shows a structural block diagram of a first network node according to another exemplary embodiment of the present disclosure;

FIG. 7 schematically shows a structural block diagram of a second network node according to an exemplary embodiment of the present disclosure; and

FIG. 8 schematically shows a structural block diagram of a second network node according to another exemplary embodiment of the present disclosure.

FIG. 9 schematically shows a networked system in accordance with exemplary embodiments of the solution described herein.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” refers to a device in a wireless communication network via which a terminal device or another network node accesses the network and receives services therefrom. The network node refers to any Network Function (NF), a base station (BS), an access point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

In some embodiments, the non-limiting terms wireless device or UE are used interchangeably. The UE herein can be any type of wireless device capable of communicating with a network node or another wireless device over radio signals, such as wireless device. The UE may also be a radio communication device, target device, D2D wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Note that although terminology from one particular wireless system, such as, for example, 3GPP LTE and/or New Radio (NR), may be used in this disclosure, this should not be seen as limiting the scope of the present disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

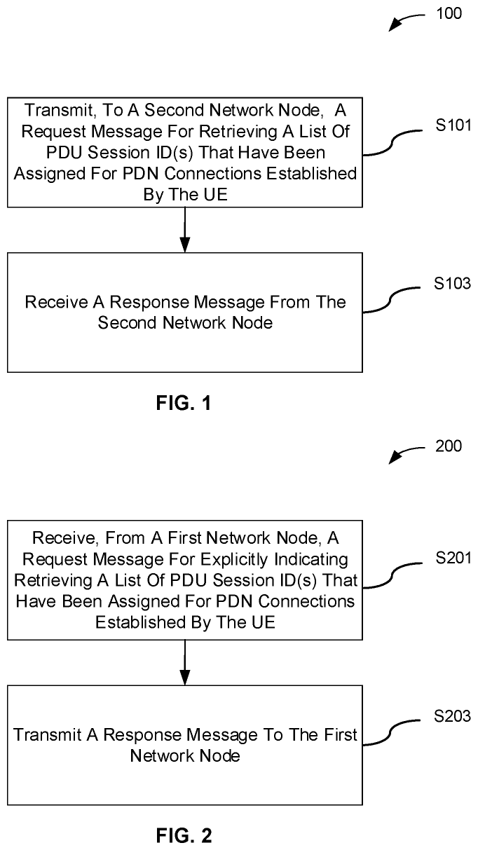

The example embodiments described herein arise in the context of a telecommunications network, including but not limited to a telecommunications network that conforms to and/or otherwise incorporates aspects of a fifth generation (5G) architecture. FIG. 9 is an example networked system 900 in accordance with example embodiments of the present disclosure. FIG. 1 specifically illustrates User Equipment (UE) 901, which may be in communication with a (Radio) Access Network (RAN) 902 and Access and Mobility Management Function (AMF) 906 and User Plane Function (UPF) 903. The AMF 906 may, in turn, be in communication with core network services including Session Management Function (SMF) 907 and Policy Control Function (PCF) 911. The core network services may also be in communication with an Application Server/Application Function (AS/AF) 913. Other networked services also include Network Slice Selection Function (NSSF) 908, Authentication Server Function (AUSF) 905, User Data Management (UDM) 912, Network Exposure Function (NEF) 909, Network Repository Function (NRF) 190, User Data Repository (UDR) 914, Network Data Analytics Function (NWDAF) 915 and Data Network (DN) 904. In some example implementations of embodiments of the present disclosure, each one of the entities in the networked system 900 are considered to be a Network Function (NF). One or more additional instances of the NFs may be incorporated into the networked system.

3GPP TS 23.502 v17.1.0 describes some exemplary scenarios/processes related to the present disclosure in Clauses 4.11.0a.5 and 4.11.4.3.6, wherein in order for a UE not supporting 5GC NAS (also described as a UE not supporting 5G) to establish a PDN connection over 4G system, e.g., EPS, or over EPC/ePDG, e.g., Wi-Fi, the SMF+PGW-C assigns/creates a unique PDU Session ID for the PDN connection.

Clause 4.11.0a.5 of 3GPP TS 23.502 v17.1.0 describes a process of PDN connection establishment, which is excerpted below.

### 4.11.0a.5 PDN Connection Establishment

During establishment of non-emergency PDN connection in the EPC, the UE and the SMF+PGW-C exchange information via Protocol Configuration Option (PCO) as described in Clause 5.15.7 of 3GPP TS 23.501 v17.2.0 (which is incorporated herein in its entirety by reference). For a UE with 5GC NAS capability disabled (i.e. N1 mode is disabled), the UE may also allocate a PDU Session ID and send it to the SMF+PGW-C via PCO. If the SMF+PGW-C supports more than one Single-Network Slice Selection Assistance Information (S-NSSAI) and the Access Point Name (APN) is valid for more than one S-NSSAI, before the SMF+PGW-C provides an S-NSSAI to the UE, the SMF+PGW-C should check such that the selected S-NSSAI is among the UE's subscribed S-NSSAIs, and that the S-NSSAI is not subject to Network Slice-Specific Authentication and Authorization (NSSAA), by retrieving the Subscribed S-NSSAI from Unified Data Management (UDM) using the Nudm_SDM_Get service operation (the SMF+PGW-C discovers and selects a UDM as described in Clause 6.3.8 of 3GPP TS 23.501 v17.2.0). If the SMF+PGW-C is in a Visited Public Land Mobile Network (VPLMN), the SMF+PGW-C uses the Nnssf_NSSelection_Get service operation to retrieve a mapping of the Subscribed S-NSSAIs to Serving PLMN S-NSSAI values. If the S-NSSAIs supported by the SMF+PGW-C are all subject to NSSAA, then the SMF+PGW-C should reject the PDN connection establishment. If the selected S-NSSAI is subject to Network Slice Admission Control (NSAC) and EPS counting is required for the S-NSSAI, the SMF+PGW-C uses the Nnsacf_NSAC_NumberOfUEsUpdate services operation and/or the Nnsacf_NSAC_NumberOfPDUsUpdate services operation to check if the selected S-NSSAI is available as described in Clause 4.11.5.9 of 3GPP TS 23.502 v17.1.0. The SMF+PGW-C uses the Nudm_SDM_Subscribe service operation to subscribe the change of the Session Management Subscription data. If the SMF+PGW-C is notified from UDM with subscription data change, the SMF+PGW-C takes actions for the PDN connection as described in Clause 5.17.2.1 of 3GPP TS 23.501 v17.2.0.

As described in 3GPP TS 23.548 v17.0.0 (which is incorporated herein in its entirety by reference), during establishment of a PDN connection, a UE that hosts Edge Enabler Client(s) (EEC(s)) may indicate to the SMF+PGW-C, in the PCO, that it supports the ability to receive ECS address(es) via NAS and to transfer the Edge Configuration Server (ECS) Address(es) to the EEC(s). If the UE indicated in the PCO that it supports the ability to receive ECS address(es) via NAS, the SMF+PGW-C may provide the ECS Address Configuration Information (as described in Clause 6.5.2 of 3GPP TS 23.548 v17.0.0) to the UE in the PCO. The SMF+PGW-C may derive the Edge Configuration Server Information based on local configuration, the UE's location, and/or UE subscription information.

The SMF+PGW-C may use the bearer modification procedure without bearer Quality of Service (QOS) update to send the UE a PCO with updated ECS Address Configuration Information as defined in Clause 6.5.2 of 3GPP TS 23.548 v17.0.0 to the UE.

During establishment of non-emergency PDN connection in the EPC, if SMF+PGW-C is selected for a UE that has 5GS subscription, the SMF may be configured to obtain the subscribed IP index from UDM as part of subscription data using the Nudm_SDM_Get service operation (the SMF+PGW-C discovers and selects a UDM as described in Clause 6.3.8 of 3GPP TS 23.501 v17.2.0).

During establishment of non-emergency PDN connection in the EPC, if SMF+PGW-C is selected for a UE that has 5GS subscription but does not support 5GC NAS and is accessing via EPC/E-UTRAN and if the SMF+PGW-C supports more than one S-NSSAI and the APN is valid for more than one S-NSSAI, the SMF+PGW-C may proceed as specified in first paragraph of this clause or select any S-NSSAI associated with the APN of the PDN connection. The SMF+PGW-C shall not provide any 5GS related parameters to the UE.

NOTE: The SMF+PGW-C knows that the UE does not support 5GS NAS if the UE does not provide PDU Session ID in PCO (see Clause 5.15.7 of 3GPP TS 23.501 v17.2.0). During establishment of emergency PDN connection:
The SMF+PGW-C is to be derived from the emergency APN or to be statically configured in the Emergency Configuration Data in MME.
5GC interworking support with N26 or without N26 is determined based on UE's 5G NAS capability and local configuration (in the Emergency Configuration Data in MME).
The S-NSSAI configured for the emergency APN in SMF+PGW-C is not sent to the UE by the SMF+PGW-C. One S-NSSAI is configured for the emergency APN.

During establishment of non-emergency PDN connection and emergency PDN connection, if SMF+PGW-C is selected for a UE that does not support 5GC NAS, the SMF+PGW-C creates unique PDU Session ID for each PDN connection of the UE.

The unique PDU Session ID can be created based on the EPS Bearer IDs assigned by the MME for the PDN Connections associated with the UE and not be in the range of PDU Session ID values that can be created by a 5GC NAS capable UE.

When the SMF+PGW-C establishes the PDN connection successfully, the SMF+PGW-C provides the ID of Policy Control Function (PCF) selected for the PDN connection in the UDM using the Nudm_UECM_Registration service operation.

Clause 4.11.4.3.6 of 3GPP TS 23.502 v17.1.0 describes a process of use of N10 interface instead of S6b, which is excerpted below.

### 4.11.4.3.6 Use of N10 Interface Instead of S6b

This clause applies to scenarios when ePDG is connected to SMF+PGW-C and S6b in not used. It is applicable for procedures specified in 3GPP TS 23.402 v17.0.0 (which is incorporated herein in its entirety by reference) including mobility between EPC/ePDG and EPC/Evolved Universal Mobile Telecommunications Service Terrestrial Radio Access Network (EUTRAN) and also for mobility between EPC/ePDG and 5GS.

When S6b, as specified in 3GPP TS 23.402 v17.0.0, is not deployed between SMF+PGW-C and Authentication, Authorization and Accounting (AAA) and the UE creates and deletes a PDN connection via ePDG connected to SMF+PGW-C, the registration and de-registration of PDN GW (i.e., PGW) is performed on the N10 interface instead of the S6b interface.

If SMF+PGW-C is selected for a UE that does not support 5GC NAS, the SMF+PGW-C determines the PDU Session ID and S-NSSAI in the same way as for PDN connection via EPC/EUTRAN as specified in Clause 4.11.0a.5 (as described previously).

As has been described for Table 1, it should be noted that for a PDN connection established via MME, the PDU Session ID value is set to 64 plus the EPS bearer ID of the default EPS bearer of the PDN connection; for a PDN connection established via ePDG, the PDU Session ID value is set to 80 plus the EPS bearer ID of the default EPS bearer of the PDN connection.

In order to avoid possible duplicated PDU Session ID assigned by the SMF+PGW-C to different PDN connections of the UE, ensuring uniqueness of the assigned PDU Session ID, the basic ideas of the present disclosure mainly consist in that
When the first network node (e.g., SMF+PGW-C) creates/assigns a unique PDU Session ID for a PDN connection being established by a UE not supporting 5G, the first network node (e.g., the SMF+PGW-C) may query the second network node (e.g., UDM) what PDU Session ID(s) have already been assigned for the UE by any SMF+PGW-C(s), by using a service operation, e.g., an Nudm_UECM_Get request service operation; then, the first network node (e.g., the SMF+PGW-C) may assign a unique PDU Session ID for the PDN connection of the UE, by taking into consideration the PDU Session ID(s) retrieved from the UDM by using a service operation, e.g., an Nudm_UECM_Get response service operation. Thus, the uniqueness of PDU Session ID assigned for the PDN connection of the UE may be ensured; and
When a PDN connection is successfully established, the first network node (e.g., SMF+PGW-C) may register the assigned PDU Session ID in the UDM by using a service operation, e.g., Nudm_UECM_Registration.

Hereinafter, a method 100 at a first network node for ensuring uniqueness of an assigned PDU session ID according to an exemplary embodiment of the present disclosure will be described with reference to FIG. 1.

The first network node may act as an NF service consumer, or similar in other future developments, that transmits a request message. In an exemplary embodiment, the first network node may be SMF+PGW-C. It should be understood that the first network node may also be any other appropriate entity that can be configured to perform the method 100 as described below, including a virtualized entity that may be implemented on cloud.

As shown in FIG. 1, the method 100 may include at least steps S101 and S103.

When the first network node needs to create/assign a unique PDU Session ID for a PDN connection being established by a UE not supporting 5G NAS (or simply, a UE not supporting 5G), the first network node may transmit, to a second network node, a request message for retrieving a list of PDU Session ID(s) that have been assigned for PDN connections established by the UE in step S101.

In an exemplary embodiment, the request message for retrieving a list of PDU Session ID(s) that have been assigned for PDN connections established by the UE may be transmitted, if handover between EPS and EPC/ePDG (such as Wi-Fi) might be involved.

It may be understood that the requested PDU Session ID(s) that have been assigned for PDN connections established by the UE may be assigned by any first network node, not limited to the requesting first network node.

The request message may be a separate request message for retrieving the list of PDU Session ID(s) that have been assigned for PDN connections established by the UE, that is, a separate request message for retrieving such a list of PDU Session ID(s) only.

In another exemplary embodiment, the request message may also be a request message for retrieving registration information that includes the list of PDU Session ID(s) that have been assigned for PDN connections established by the UE.

The second network node may act as an NF service producer, or similar in other future developments, that receives a request message. In an exemplary embodiment, the second network node may be UDM. It should be understood that the second network node may also be any other appropriate entity, including a virtualized entity that may be implemented on cloud.

Then in step S103, the first network node may receive a corresponding response message from the second network node.

In an exemplary embodiment, the request message may be transmitted via an Nudm_UECM_Get request service operation, and accordingly, the response message may be transmitted via an Nudm_UECM_Get response service operation.

In response to the request message transmitted in step S101, the response message received in step S103 from the second network node may include a list of PDU Session ID(s) that have been assigned for PDN connections established by the UE. Accordingly, the first network node may assign a PDU Session ID for the PDN connection being established by the UE by taking into consideration the received list of PDU Session ID(s). For example, the first network node may assign, for the PDN connection being established by the UE, a PDU Session ID that is not within the received list of PDU Session ID(s).

In another exemplary embodiment, the response message received in step S103 from the second network node may include an empty list of PDU Session ID(s) that have been assigned for PDN connections established by the UE, or may not include such a list. In this case, the first network node may assign a PDU Session ID for the PDN connection being established by the UE in a conventional way.

It may be understood that in the exemplary embodiment where the request message is a separate request message for retrieving the list of PDU Session ID(s) that have been assigned for PDN connections established by the UE, the response message may only include the requested list of PDU Session ID(s) that have been assigned for PDN connections established by the UE.

In the other exemplary embodiment where the request message is a request message for retrieving registration information, wherein the registration information includes the list of PDU Session ID(s) that have been assigned for PDN connections established by the UE, the response message may be include the corresponding registration information containing the list of PDU Session ID(s) that have been assigned for PDN connections established by the UE.

In a case where the PDN connection assigned with the PDU Session ID is successfully established, the first network node may transmit, to the second network node, registration information including the assigned PDU Session ID.

In an exemplary embodiment, the registration information including the assigned PDU Session ID may be transmitted via an Nudm_UECM_Registration service operation.

Hereinafter, a method 200 performed by a second network node for ensuring uniqueness of an assigned PDU session ID according to an exemplary embodiment of the present disclosure will be described with reference to FIG. 2. It should be understood that the method 200 performed by the second network node corresponds to the method 100 performed by the first network node as previously described. Thus, some description of the method 200 may refer to that of method 100, and thus will be omitted for simplicity.

The second network node may act as an NF service producer, or similar in other future developments, that receives a request message. In an exemplary embodiment, the second network node may be UDM. It should be understood that the second network node may also be any other appropriate entity that can be configured to perform the method 200 as described below, including a virtualized entity that may be implemented on cloud.

As shown in FIG. 2, the method 200 may include at least steps S201 and S203.

In step S201, the second network node may receive, from a first network node, a request message for retrieving a list of PDU Session ID(s) that have been assigned for PDN connections established by a UE not supporting 5G.

The first network node may act as an NF service consumer, or similar in other future developments, that transmits a request message. In an exemplary embodiment, the first network node may be SMF+PGW-C. It should be understood that the first network node may also be any other appropriate entity.

The request message may be a separate request message for retrieving the list of PDU Session ID(s) that have been assigned for PDN connections established by the UE.

In another exemplary embodiment, the request message may also be a request message for retrieving registration information, wherein the registration information includes the list of PDU Session ID(s) that have been assigned for PDN connections established by the UE.

Then in step S203, the second network node may transmit a response message to the first network node.

In an exemplary embodiment, the request message may be transmitted via an Nudm_UECM_Get request service operation, and accordingly, the response message may be transmitted via an Nudm_UECM_Get response service operation.

The response message may include a list of PDU Session ID(s) that have been assigned for PDN connections established by the UE, an empty list of PDU Session ID(s) that have been assigned for PDN connections established by the UE, or may not include such a list.

It may be understood that in the exemplary embodiment where the request message is a separate request message for retrieving the list of PDU Session ID(s) that have been assigned for PDN connections established by the UE, the response message may only include the requested list of PDU Session ID(s) that have been assigned for PDN connections established by the UE.

In the other exemplary embodiment where the request message is a request message for retrieving registration information, wherein the registration information includes the list of PDU Session ID(s) that have been assigned for PDN connections established by the UE, the response message may include the corresponding registration information containing the list of PDU Session ID(s) that have been assigned for PDN connections established by the UE.

In an exemplary embodiment, in a case where the PDN connection assigned by the first network node with the PDU Session ID is successfully established, the second network node may receive, from the first network node, registration information including the PDU Session ID assigned by the first network node.

In an exemplary embodiment, the registration information including the assigned PDU Session ID may be received via an Nudm_UECM_Registration service operation.

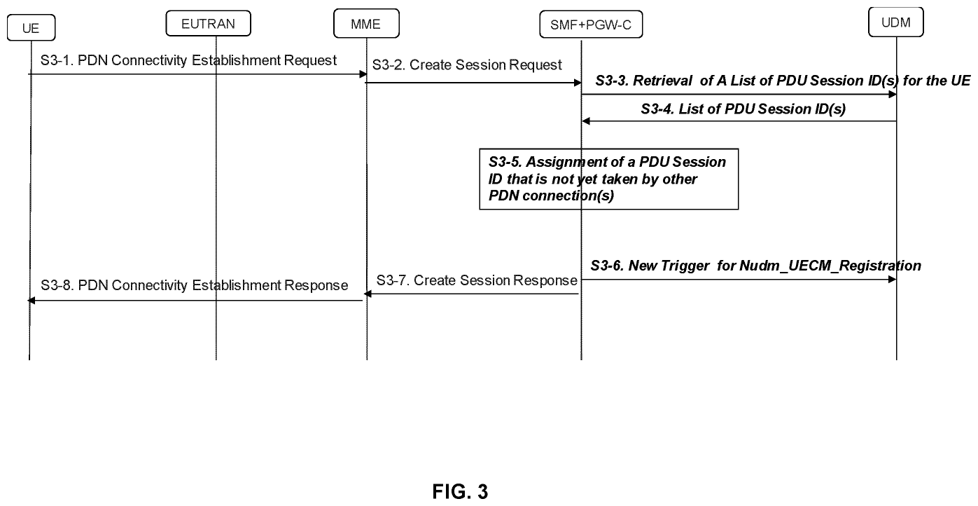

FIG. 3 schematically shows an exemplary signaling sequence in an exemplary PDN connection establishment process from a UE not supporting 5G via MME, in which the methods of FIGS. 1 and 2 according to the exemplary embodiments of the present disclosure may be applied. Some description of the exemplary signaling sequence diagram as shown in FIG. 3 may refer to that of methods 100 and 200 as previously described, and thus will be omitted here for simplicity.

In the following description on the exemplary signaling sequence diagram of FIG. 3, SMF+PGW-C is taken as an example of the first network node as previously described, and UDM is taken as an example of the second network node as previously described.

It should be understood that the above exemplary entities are only used here for illustration but without any limitation. Respective entities other than those mentioned here or any combination thereof may cooperate to perform the PDN connection establishment process from the UE not supporting 5G via MME, as long as the methods 100 and 200 may be implemented respectively.

It should be noted that the description below mainly focuses on signaling related to the methods 100 and 200, and some other signaling is not described in detail to avoid obscuring the principle of the present disclosure. In FIG. 3, modification on the signaling related to the methods 100 and 200 is shown in Bold Italics, in which e.g., Signaling S3-3˜S3-6 are involved.

If handover between EPS and EPC/ePDG may happen, when establishing a PDN connection from a UE not supporting 5G via MME,
in S3-1, the UE may send a PDN Connectivity Establishment Request to MME;
in S3-2, the MME may send a Create Session Request to SMF+PGW-C;
in S3-3, the SMF+PGW-C may send a request message for retrieving, from the UDM, a list of PDU Session ID(s) that have been assigned by any SMF+PGW-C(s), e.g., via an Nudm_UECM_Get request service operation;
in S3-4, the SMF+PGW-C may retrieve a list of PDU Session ID(s) from the UDM in this example, e.g., via an Nudm_UECM_Get response service operation;
in S3-5, the SMF+PGW-C may assign a PDU Session ID for the PDN connection being established by the UE by taking into consideration the received list of PDU Session ID(s); for example, the SMF+PGW-C may assign a PDU Session ID that is not within the received list of PDU Session ID(s);
in S3-6, in a case where the PDN connection assigned with the PDU Session ID is successfully established, the SMF+PGW-C may transmit, to the UDM, registration information including the assigned PDU Session ID e.g., via an Nudm_UECM_Registration service operation;
in S3-7, the SMF+PGW-C may send a Create Session Response to the MME; and
in S3-8, the UE may receive a PDN Connectivity Establishment Response from the MME.

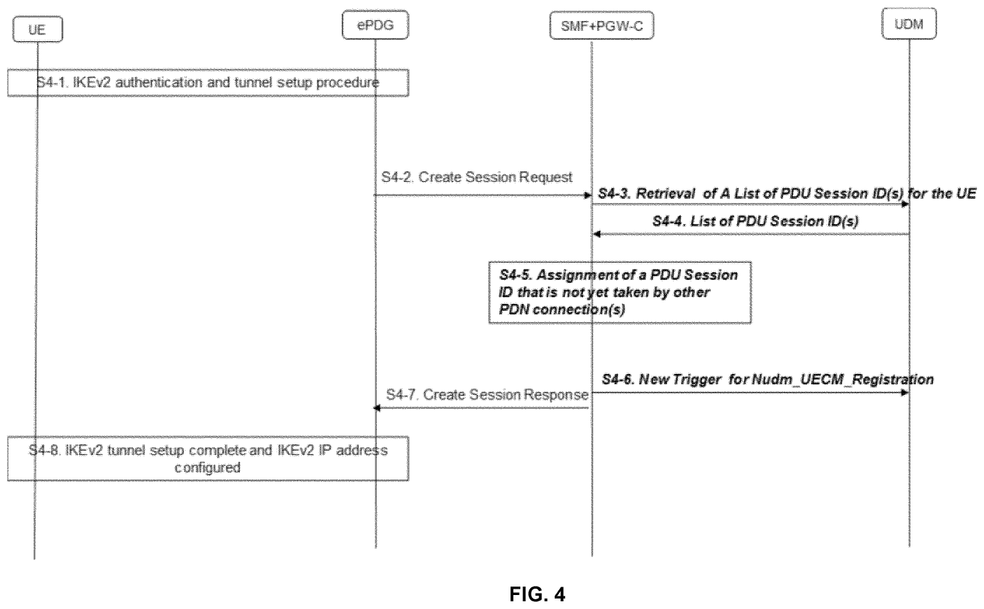

FIG. 4 schematically shows another exemplary signaling sequence in an exemplary PDN connection establishment process from a UE not supporting 5G via ePDG, in which the methods of FIGS. 1 and 2 according to the exemplary embodiments of the present disclosure may be applied. Some description of the exemplary signaling sequence diagram as shown in FIG. 4 may refer to that of methods 100 and 200 as previously described, and thus will be omitted here for simplicity.

In the following description on the exemplary signaling sequence diagram of FIG. 4, SMF+PGW-C is taken as an example of the first network node as previously described, and UDM is taken as an example of the second network node as previously described.

It should be understood that the above exemplary entities are only used here for illustration but without any limitation. Respective entities other than those mentioned here or any combination thereof may cooperate to perform the PDN connection establishment process from the UE not supporting 5G via ePDG, as long as the methods 100 and 200 may be implemented respectively.

It should be noted that the description below mainly focuses on signaling related to the methods 100 and 200, and some other signaling is not described in detail to avoid obscuring the principle of the present disclosure. In FIG. 4, modification on the signaling related to the methods 100 and 200 is shown in Bold Italics, in which e.g., Signaling S4-3˜S4-6 are involved.

It can be seen that compared to FIG. 3, ePDG is involved instead of MME in FIG. 4.

Similarly, if handover between EPS and EPC/ePDG may happen, when establishing a PDN connection from a UE not supporting 5G via ePDG,
in S4-1, the UE performs an Internet Key Exchange Version 2 (IKEv2) authentication and tunnel setup procedure;
in S4-2, the ePDG may send a Create Session Request to SMF+PGW-C;
in S4-3, the SMF+PGW-C may send a request message for retrieving, from the UDM, a list of PDU Session ID(s) that have been assigned by any SMF+PGW-C(s), e.g., via an Nudm_UECM_Get request service operation;
in S4-4, the SMF+PGW-C may retrieve a list of PDU Session ID(s) from the UDM in this example, e.g., via an Nudm_UECM_Get response service operation;
in S4-5, the SMF+PGW-C may assign a PDU Session ID for the PDN connection being established by the UE by taking into consideration the received list of PDU Session ID(s); for example, the SMF+PGW-C may assign a PDU Session ID that is not within the received list of PDU Session ID(s);
in S4-6, in a case where the PDN connection assigned with the PDU Session ID is successfully established, the SMF+PGW-C may transmit, to the UDM, registration information including the assigned PDU Session ID e.g., via an Nudm_UECM_Registration service operation; and
in S4-7, the SMF+PGW-C may send a Create Session Response to the ePDG;
in S4-8, the IKEv2 tunnel setup is complete, and IKEv2 IP address is configured.

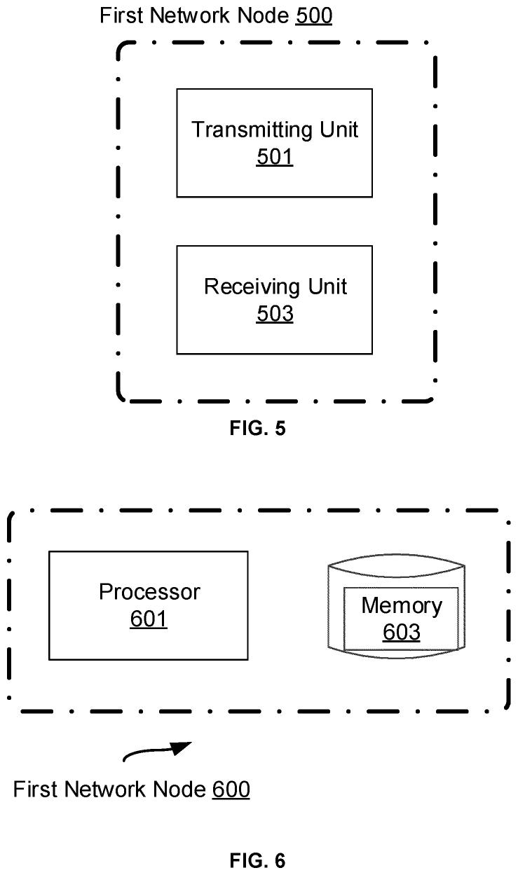

Hereinafter, a structure of a first network node according to an exemplary embodiment of the present disclosure will be described with reference to FIG. 5. FIG. 5 schematically shows a block diagram of the first network node 500 according to an exemplary embodiment of the present disclosure. The first network node 500 in FIG. 5 may perform the method 100 with reference to FIG. 1. Accordingly, some detailed description on the first network node 500 may refer to the corresponding description of the method 100 in FIG. 1, and thus will be omitted here for simplicity.

As shown in FIG. 5, the first network node 500 may include at least a transmitting unit 501 and a receiving unit 503.

The transmitting unit 501 may be configured to transmit, to a second network node, a request message for retrieving a list of PDU Session ID(s) that have been assigned for PDN connections established by a UE.

The receiving unit 503 may be configured to receive a response message from the second network node.

The request message may be a separate request message for retrieving the list of PDU Session ID(s) that have been assigned for PDN connections established by the UE.

Alternatively, the request message may be a request message for retrieving registration information that includes the list of PDU Session ID(s) that have been assigned for PDN connections established by the UE.

The first network node 500 may include an assigning unit (not shown).

In an exemplary embodiment, the response message includes no or an empty list of PDU Session ID(s) that have been assigned for PDN connections established by the UE. In this case, the assigning unit may be configured to assign a PDU Session ID for a PDN connection being established by the UE.

In an exemplary embodiment, the response message includes a list of PDU Session ID(s) that have been assigned for PDN connections established by the UE. In this case, the assigning unit may be configured to assign, for a PDN connection being established by the UE, a PDU Session ID that is not within the received list of PDU Session ID(s).

The list of PDU Session ID(s) may be contained in registration information included in the response message.

In an exemplary embodiment, the request message may be transmitted by the transmitting unit 501 via an Nudm_UECM_Get request service operation, and the response message may be received by the receiving unit 503 via an Nudm_UECM_Get response service operation.

In an exemplary embodiment, the transmitting unit 501 may be further configured to transmit, to the second network node, registration information including the assigned PDU Session ID, in a case where the PDN connection assigned with the PDU Session ID is successfully established.

In an exemplary embodiment, the registration information including the assigned PDU Session ID may be transmitted by the transmitting unit 501 via an
Nudm_UECM_Registration service operation.

In an exemplary embodiment, the UE may not support 5G, the first network node may be SMF+PGW-C, and the second network node may be UDM.

Hereinafter, a structure of a first network node according to another exemplary embodiment of the present disclosure will be described with reference to FIG. 6. FIG. 6 schematically shows a block diagram of a first network node 600 according to an exemplary embodiment of the present disclosure. The first network node 600 in FIG. 6 may perform the method 100 as described previously with reference to FIG. 1. Accordingly, some detailed description on the first network node 600 may refer to the corresponding description of the method 100 in FIG. 1, and thus will be omitted here for simplicity.

As shown in FIG. 6, the first network node 600 includes at least one processor 601 and at least one memory 603. The at least one processor 601 includes e.g., any suitable CPU (Central Processing Unit), microcontroller, DSP (Digital Signal Processor), etc., capable of executing computer program instructions. The at least one memory 603 may be any combination of a RAM (Random Access Memory) and a ROM (Read Only Memory). The at least one processor memory 603 may also include persistent storage, which, for example, can be any single one or combination of magnetic memory, optical memory, or solid state memory or even remotely mounted memory.

The at least one memory 603 stores instructions executable by the at least one processor 601. The instructions, when loaded from the at least one memory 603 and executed on the at least one processor 601, may cause the first network node 600 to perform the actions, e.g., of the procedures as described earlier in conjunction with FIG. 1, and thus will be omitted here for simplicity.

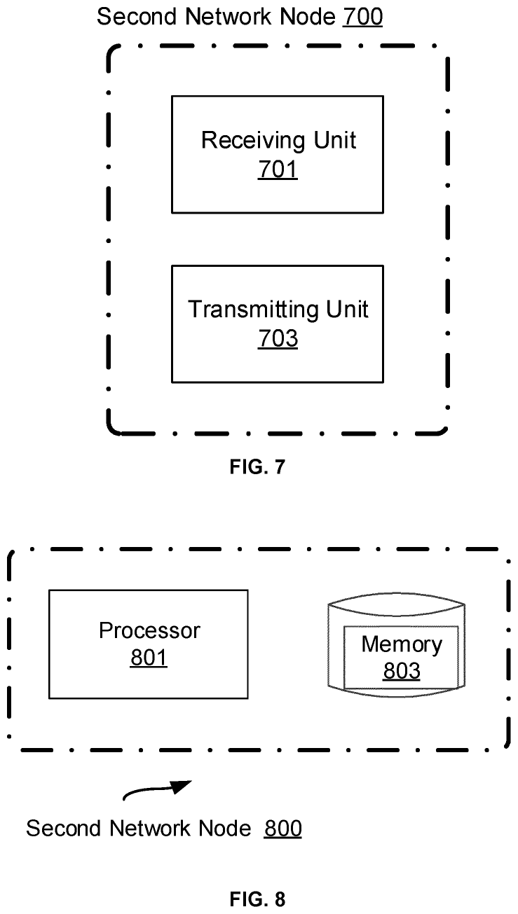

Hereinafter, a structure of a second network node according to an exemplary embodiment of the present disclosure will be described with reference to FIG. 7. FIG. 7 schematically shows a block diagram of the second network node 700 according to an exemplary embodiment of the present disclosure. The second network node 700 in FIG. 7 may perform the method 200 as described previously with reference to FIG. 2. Accordingly, some detailed description on the second network node 700 may refer to the corresponding description of the method 200 in FIG. 2, and thus will be omitted here for simplicity.

As shown in FIG. 7, the second network node 700 may include at least a receiving unit 701 and a transmitting unit 703.

The receiving unit 701 may be configured to receive, from a first network node, a request message for retrieving a list of PDU Session ID(s) that have been assigned for PDN connections established by a UE.

The transmitting unit 703 may be configured to transmit a response message to the first network node.

The request message may be a separate request message for retrieving the list of PDU Session ID(s) that have been assigned for PDN connections established by the UE.

Alternatively, the request message may be a request message for retrieving registration information that comprises the list of PDU Session ID(s) that have been assigned for PDN connections established by the UE.

In an exemplary embodiment, the response message may include one of:
no list of PDU Session ID(s) that have been assigned for PDN connections established by the UE,
an empty list of PDU Session ID(s) that have been assigned for PDN connections established by the UE, or
a list of PDU Session ID(s) that have been assigned for PDN connections established by the UE.

The list of PDU Session ID(s) may be contained in registration information included in the response message.

In an exemplary embodiment, the request message may be received by the receiving unit 701 via an Nudm_UECM_Get request service operation, and the response message may be transmitted by the transmitting unit 703 via an Nudm_UECM_Get response service operation.

In an exemplary embodiment, the receiving unit 701 may be further configured to receive, from the first network node, registration information including the PDU Session ID assigned by the first network node, in a case where the PDN connection assigned by the first network node with the PDU Session ID is successfully established.

In an exemplary embodiment, the registration information including the PDU Session ID assigned by the first network node may be received by the receiving unit 701 via an Nudm_UECM_Registration service operation.

In an exemplary embodiment, the UE may not support 5G, the first network node may be SMF+PGW-C, and the second network node may be UDM.

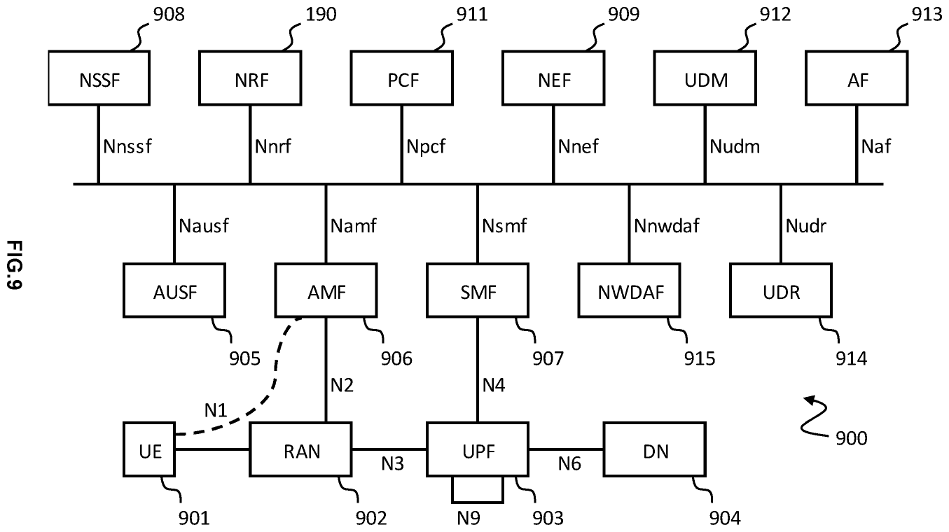

Hereinafter, a structure of a second network node according to another exemplary embodiment of the present disclosure will be described with reference to FIG. 8. FIG. 8 schematically shows a block diagram of a second network node 800 according to an exemplary embodiment of the present disclosure. The second network node 800 in FIG. 8 may perform the method 200 as described previously with reference to FIG. 2. Accordingly, some detailed description on the second network node 800 may refer to the corresponding description of the method 200 in FIG. 2, and thus will be omitted here for simplicity.

As shown in FIG. 8, the second network node 800 includes at least one processor 801 and at least one memory 803. The at least one processor 801 includes e.g., any suitable CPU (Central Processing Unit), microcontroller, DSP (Digital Signal Processor), etc., capable of executing computer program instructions. The at least one memory 803 may be any combination of a RAM (Random Access Memory) and a ROM (Read Only Memory). The at least one processor memory 803 may also include persistent storage, which, for example, can be any single one or combination of magnetic memory, optical memory, or solid state memory or even remotely mounted memory.

The at least one memory 803 stores instructions executable by the at least one processor 801. The instructions, when loaded from the at least one memory 803 and executed on the at least one processor 801, may cause the second network node 800 to perform the actions, e.g., of the procedures as described earlier respectively in conjunction with FIG. 2, and thus will be omitted here for simplicity.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 601 causes the first network node 600 to perform the actions, e.g., of the procedures described earlier in conjunction with FIG. 1; or code/computer readable instructions, which when executed by the at least one processor 801 causes the second network node 800 to perform the actions, e.g., of the procedures described earlier respectively in conjunction with FIG. 2.

The computer program product may be configured as a computer program code structured in computer program modules. The computer program modules could essentially perform the actions of the flow illustrated in any of FIGS. 1 to 2.

The processor may be a single CPU (Central processing unit), but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations, elements, or components, and combinations thereof, but do not preclude the presence or addition of one or more other features, integers, steps, operations, elements, or components, and combinations thereof. Further, all terms used in the claims are to be interpreted according to their ordinary meaning in the technical field, unless explicitly defined otherwise herein. All references to ““a/an/the element, apparatus, component, means, module, step, etc.”” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

1.-26. (canceled)

27. A method performed by a first network node, comprising:
transmitting, to a second network node, during establishment of a Packet Data Network, PDN, connection, a request message for retrieving a list of Packet Data Unit, PDU, Session ID(s) that have been already registered for a User Equipment, UE; and
receiving a response message from the second network node;
wherein the second network node is a Unified Data Management, UDM.

28. The method of claim 27, wherein the response message comprises a list of PDU Session ID(s) that have been already registered for PDN connections established by the UE, and the method further comprises:
assigning, for the PDN connection being established by the UE, a PDU Session ID that is not within the received list of PDU Session ID(s).

29. The method of claim 27, wherein the request message is transmitted via an Nudm_UECM_Get request service operation, and the response message is received via an Nudm_UECM_Get response service operation.

30. The method of claim 27, further comprising:
in a case where the PDN connection assigned with the PDU Session ID is successfully established, transmitting, to the second network node, registration information comprising the assigned PDU Session ID.

31. The method of claim 30, wherein the registration information comprising the assigned PDU Session ID is transmitted via an Nudm_UECM_Registration service operation.

32. The method of claim 27, wherein
the UE does not support 5G, and
the first network node is Session Management Function, SMF,+ PDN Gateway-Control plane, PGW-C.

33. The method of claim 27, wherein the request message comprises a request message for retrieving only the list of PDU Session ID(s) that have been assigned for PDN connections established by the UE.

34. The method of claim 27, wherein the request message comprises a request message for retrieving registration information that comprises the list of PDU Session ID(s) that have been assigned for PDN connections established by the UE.

35. The method of claim 27, wherein the response message comprises no or an empty list of PDU Session ID(s) that have been assigned for PDN connections established by the UE, and the method further comprises:
assigning a PDU Session ID for a PDN connection being established by the UE.

36. The method of claim 27, wherein the list of PDU Session ID(s) is comprised in registration information in the response message.

37. A method performed by a second network node, comprising:
receiving, from a first network node, during establishment of a Packet Data Network, PDN, connection, a request message for retrieving a list of Packet Data Unit, PDU, Session ID(s) that have been already registered for a User Equipment, UE; and
transmitting a response message to the first network node;
wherein the second network node is a Unified Data Management, UDM.

38. The method of claim 37, wherein the response message comprises a list of PDU Session ID(s) that have been already registered for PDN connections established by the UE.

39. The method of claim 37, wherein the request message is received via an Nudm_UECM_Get request service operation, and the response message is transmitted via an Nudm_UECM_Get response service operation.

40. The method of claim 37, further comprising:
in a case where the PDN connection assigned by the first network node with the PDU Session ID is successfully established, receiving, from the first network node, registration information comprising the PDU Session ID assigned by the first network node.

41. The method claim 40, wherein the registration information comprising the PDU Session ID assigned by the first network node is received via an Nudm_UECM_Registration service operation.

42. The method of claim 37, wherein
the UE does not support 5G, and
the first network node is Session Management Function, SMF,+ PDN Gateway-Control plane, PGW-C.

43. The method of claim 37, wherein the request message comprises a request message for retrieving only the list of PDU Session ID(s) that have been assigned for PDN connections established by the UE.

44. The method of claim 37, wherein the request message comprises a request message for retrieving registration information that comprises the list of PDU Session ID(s) that have been assigned for PDN connections established by the UE.

45. The method of claim 37, wherein the response message comprises one of:
no list of PDU Session ID(s) that have been assigned for PDN connections established by the UE, and
an empty list of PDU Session ID(s) that have been assigned for PDN connections established by the UE.

46. The method of claim 37, wherein the list of PDU Session ID(s) is comprised in registration information in the response message.

47. A first network node comprising:
at least one processor, and
at least one memory, storing instructions which, when executed on the at least one processor, cause the first network node to:
transmit, to a second network node, during establishment of a Packet Data Network, PDN, connection, a request message for retrieving a list of Packet Data Unit, PDU, Session ID(s) that have been already registered for a User Equipment, UE; and
receive a response message from the second network node;
wherein the second network node is a Unified Data Management, UDM.

48. A second network node, comprising:
at least one processor, and
at least one memory, storing instructions which, when executed on the at least one processor, cause the second network node to:
receive, from a first network node, during establishment of a Packet Data Network, PDN, connection, a request message for retrieving a list of Packet Data Unit, PDU, Session ID(s) that have been already registered for a User Equipment, UE; and
transmit a response message to the first network node;
wherein the second network node is a Unified Data Management, UDM.
